(19) United States
(12) Patent Application Publication
(10) Pub. No.: US 2017/0259165 A1
(43) Pub. Date: Sep. 14, 2017

(54) PROCESS FOR CREATING MULTIPLE-IN-ONE JIGSAW PUZZLES AND FOR CREATING ARTWORK FROM SINGLE IMAGES

(71) Applicants: James L. Prentice, North Hills, CA (US); Daniel F. Claffey, Stevenson Ranch, CA (US)

(72) Inventors: James L. Prentice, North Hills, CA (US); Daniel F. Claffey, Stevenson Ranch, CA (US)

(21) Appl. No.: 15/451,725

(22) Filed: Mar. 7, 2017

Related U.S. Application Data
(60) Provisional application No. 62/305,251, filed on Mar. 8, 2016.

(51) Int. Cl. A63F 3/00; A63F 9/06; A63F 13/822; A63F 9/10

(52) U.S. Cl. CPC A63F 3/00097; A63F 9/10; A63F 9/0669; A63F 13/822

(57) ABSTRACT

In a method for taking an image or a portion of an image and replicating the image within an array, the images within the array are manipulated, such as by rotating or flipping the images or creating mirror-images of the original image or portion of the image, to create symmetrical images which relate to the original image but have a different appearance. Such modified images can be used in creating jigsaw puzzles, fabric designs, clothing patterns and the like.

### RELATED APPLICATION

This application claims priority to U.S. Provisional Application Ser. No. 62/305,251, filed Mar. 8, 2016.

### BACKGROUND OF THE INVENTION

The present invention generally relates to jigsaw puzzles and the creation of design artwork. More particularly, the present invention relates to a process for creating multiple-in-one jigsaw puzzles and design artwork from a single manipulated image.

Jigsaw puzzles are well-known and have been in existence for many years. A typical, traditional jigsaw puzzle comprises an image which is laminated onto a material, such as cardboard. The laminated material is cut or cast into a number of interlocking pieces such that they can be reassembled into a completed puzzle displaying the original image.

A set of pieces, sometimes referred to as edge pieces, define the outer periphery of the puzzle when assembled. The outer periphery is generally a continuous edge, and may often be rectangular, although other geometric or even irregular shapes may be defined.

Jigsaw puzzles can offer a pleasant, wholesome way to unwind and relax. The assembled puzzles are attractive, and often make those assembling the puzzle more familiar with the classic work of art, geographic photo, etc. Assembling jigsaw puzzles is a nice hobby, which is not overly taxing or overly expensive and can easily be done as a solitary pursuit or in the company of others.

The level of difficulty of a particular jigsaw puzzle is often found in the level of detail or complicated nature of the photograph or image and the number of jigsaw puzzle pieces which comprise the entire puzzle. The fewer the pieces and the more simple the design, the easier the puzzle is to assemble.

Conversely, the more complicated and detailed the image and the more jigsaw puzzle pieces involved in the puzzle, typically involves a more complicated puzzle which takes additional skill and/or time to complete.

Jigsaw puzzles are typically offered as a single puzzle, wherein the one or more users assemble a single image using the various jigsaw puzzle pieces. Upon completing the puzzle it is typically disassembled and when assembled in the future comprises the same image. The purchase of multiple puzzles is required to assemble different images.

Artwork or designs are often used in creating fabric and other textiles which may be used in creating objects, such as clothing, purses, carpets, etc. Oftentimes, these designs are created using repeated geometric designs or well-known objects in a predictable, repeated fashion. Such designs are typically symmetrical so as to be pleasing to the eye. However, creating new and unique designs which still meet these criteria can be very difficult.

Accordingly, there is a need for processes of creating multiple design images from a single base image by manipulating the base image into multiple symmetrical designs. Such designs can be used to create multiple-in-one jigsaw puzzles or as fabric designs or designs in printed onto other articles. The present invention fulfills these needs, and provides other related advantages.

### BRIEF DESCRIPTION OF THE DRAWINGS

The accompanying drawings illustrate the invention. In such drawings:

FIG. 1 illustrates an example of a process for creating a four-in-one jigsaw puzzle;

FIG. 2 is a photographic representation of a quadrant array similar to FIG. 1;

FIG. 3 is similar to FIGS. 1 and 2, showing the step of providing a base image within a first quadrant;

FIG. 4 is similar to FIGS. 2 and 3, showing a illustrating the placement of a mirror image of the base image in a second quadrant;

FIG. 5 is similar to FIGS. 2-4, illustrating placement of an image in a third quadrant;

FIG. 6 is similar to FIGS. 2-5, illustrating placement of an image in the fourth quadrant;

FIG. 7 is similar to FIG. 6, illustrating how images in the quadrant may be rotated to create a symmetrical design;

FIG. 8 illustrates the overall image created in FIG. 7 cut into individual jigsaw puzzle pieces;

FIG. 9 illustrates how the jigsaw puzzle pieces can be used to create other arrangements of images;

FIG. 10 is similar to FIG. 9, illustrating an alternative design utilizing the same jigsaw puzzle pieces as utilized in FIG. 6;

FIGS. 11 and 12 illustrate the process for creating a third puzzle image from the base image illustrated in FIG. 6;

FIGS. 13 and 14 illustrate the process for creating a fourth puzzle image from the same puzzle pieces shown in FIG. 6;

FIG. 15 shows an alternate method of creating a four-in-one jigsaw puzzle;

FIG. 16 shows additional steps of the process illustrated in FIG. 15;

FIG. 17 illustrates how the processes of FIGS. 15 and 16 can be utilized to create symmetrical images utilizing art work representing virtually any object;

FIGS. 18-20 are similar to FIG. 17, illustrating other images that may be created utilizing the process of FIGS. 15 and 16;

FIG. 21 illustrates the process of creating art work from a single image utilizing the basic concepts from FIGS. 15 and 16;

FIG. 22 illustrate the process for creating art work from a single image in accordance with the present invention;

FIG. 23 expands upon the process shown in FIG. 22;

FIG. 24 illustrates the manner in which the process of FIGS. 22 and 23 may be utilized to create a symmetrical image from an asymmetrical photograph;

FIGS. 25-31 illustrate various patterns created utilizing photographs in a manner similar to that shown in FIG. 24;

FIG. 32 shows another aspect in which the processes of the present invention may be utilized, in particular in connection with a puzzle app for a mobile device;

FIG. 33 illustrates an alternative embodiment for the app illustrating FIG. 32;

FIG. 34 illustrates the processes for creating two images from the same puzzle pieces to be utilized in connection with the apps of FIGS. 32 and 33;

FIG. 35 illustrates the processes for creating further images for utilizing the same puzzle pieces for use in connection with the apps of FIGS. 32 and 33.

### SUMMARY OF THE INVENTION

The present invention resides in a process for creating a symmetrical art pattern from a base image. In one form, the invention may be utilized to create a symmetrical art pattern from an asymmetrical base image for use in fabric designs, etc. The process comprises the steps of setting a shape and outer perimeter of the symmetrical art pattern defined by an array of similarly shaped sectioning areas, and then attaching a base image to the first sectioning area. The base image is manipulated to create one or more manipulated images which are thereafter attached onto a second and any additional sectioning area. The process results in an overall symmetrical art pattern.

The process may advantageously be used to create a multiple-in-one jigsaw puzzle. In this case the shape and outer perimeter of the jigsaw puzzle is set and defined by an array of similarly shaped sectioning areas. A base image is attached onto the first sectioning area, and the base image is then manipulated to create one or more manipulated images. These manipulated images are attached onto a second and any additional sectioning areas to create an overall symmetrical image. Once complete, the array is cut into individual jigsaw puzzle pieces.

Each similarly shaped sectioning area has a defined perimeter boundary which, when rotated, aligns with the perimeter boundary of an adjacent sectioning area. In a particularly preferred embodiment, the array of similarly shaped sectioning areas comprises rectangles. The jigsaw puzzle pieces within each sectioning area are cut according to the same pattern in order to accomplish the desired result following the manipulating steps, which may comprise the steps of creating a mirror image of the base image and/or rotating the base image.

The base image may be asymmetrical and may further comprise a portion of a recognizable article or thing.

In still another preferred embodiment, a second base image may be provided on a backside of the first sectioning area and then the foregoing steps may be utilized on the back face of the original jigsaw puzzle to create a second multiple-in-one jigsaw puzzle. Moreover, all of the aforementioned process steps may be accomplished on a mobile electronic device.

Other features and advantages of the present invention will become apparent from the following more detailed description, taking in conjunction with the accompanying drawings which illustrate, by way of example, the principles of the invention.

### DETAILED DESCRIPTION OF THE PREFERRED EMBODIMENTS

As shown in the accompanying drawings, for purposes of illustration, the present invention, in one embodiment thereof, comprises a process for creating and manufacturing a multiple-in-one jigsaw puzzle utilizing a base image repeatedly manipulated in order to create multiple symmetrical and interesting puzzle designs using the same set of jigsaw puzzle pieces.

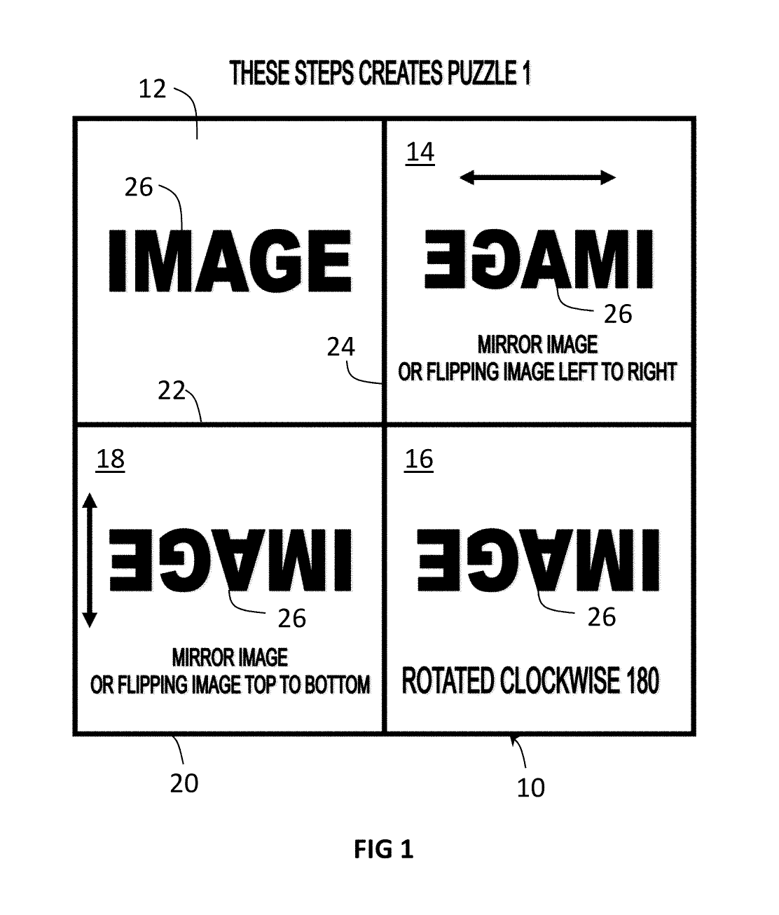

With reference now to FIG. 1, an area defining the shape and outer perimeter 10 of the resulting jigsaw puzzle is predetermined and created. This area having a defined perimeter 10 is formed into an array by sectioning areas of the overall resulting image 10. By way of example, a generally rectangular array 10 is shown having four identical quadrants 12-18 arranged in a 2×2 format. Each of the quadrants 12-18 is generally the same shape and size, in this case generally quadrilateral. The array or final image 10 is defined by an outer perimeter edge 20 which encompasses all of the areas or quadrants 12-16. Moreover, in the illustrated example, internal boundaries 22 and 24 of the quadrants 12-16 are formed by bisecting horizontal and vertical edges 22 and 24.

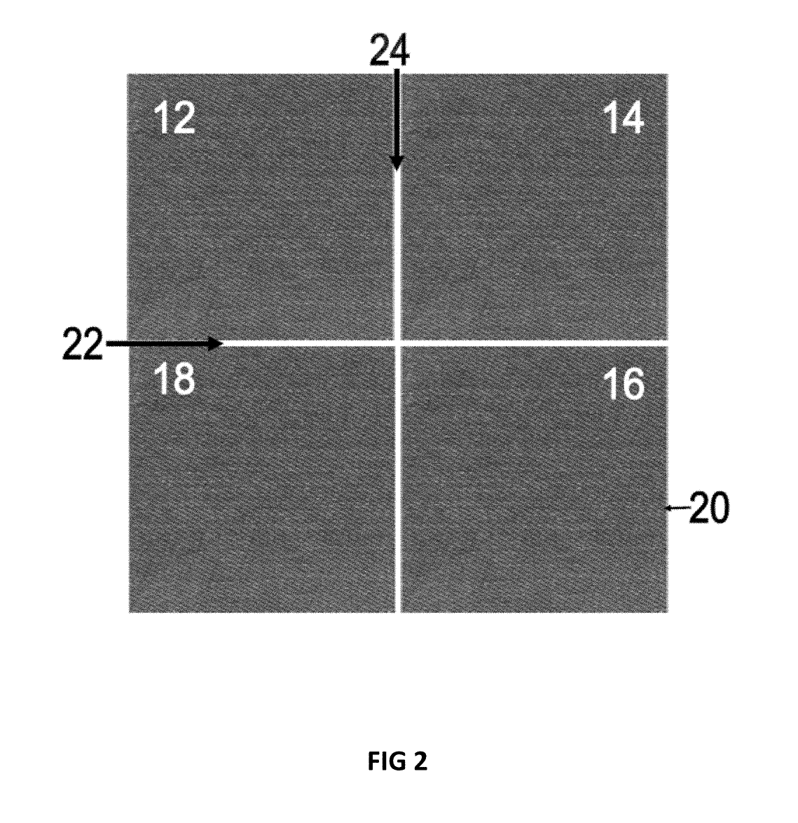

FIG. 2 is a photographic representation of such a quadrant array having substantially similar sectioned areas, in the form of quadrants 12-18 which have an outer perimeter edge 20 and internal edges 22 and 24. It can be seen in FIGS. 1 and 2 that the sectioned areas or quadrants 12-16 are of generally the same size and configuration, in accordance with the present invention. However, the combination of the images and jigsaw puzzle pieces in the four quadrants 12-18 combined forms the overall image or puzzle 10 of the entire area or array.

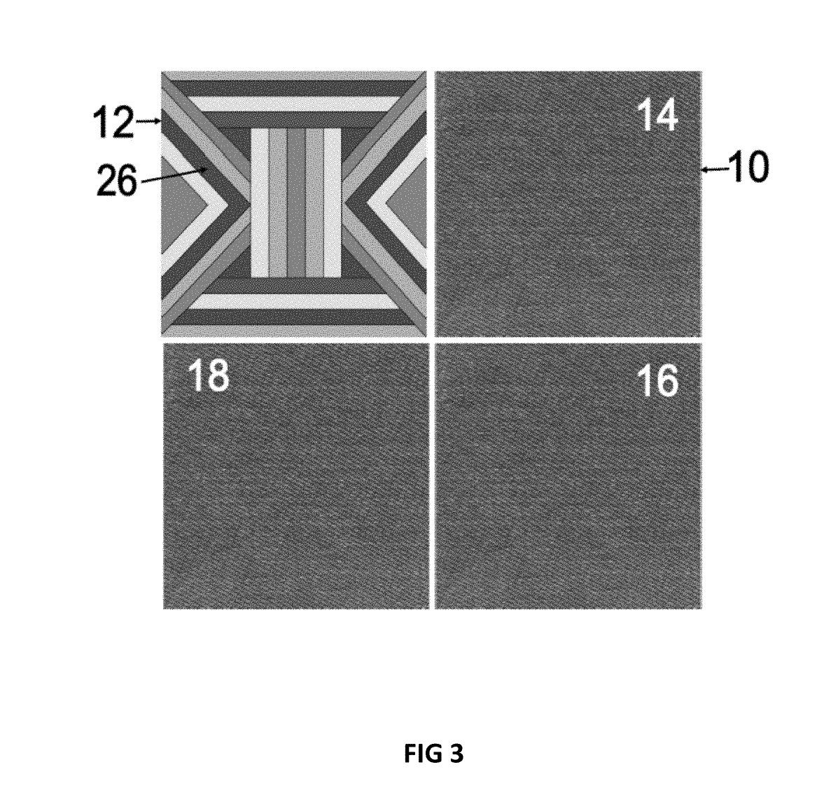

With reference now to FIGS. 1 and 3, an original, base image 26 is provided and is inserted into the first quadrant 12, defining the upper left-hand quadrant in the illustrated example. The base image 26 can comprise a variety of asymmetrical lines, which may be of various thicknesses and colors, as illustrated, or may comprise an asymmetrical image of geometric symbols and designs or the like, or may even comprise a photograph which is asymmetrical or symmetrical. However, if the base image 26 were inserted identically into each of the quadrants 12-18 an unpleasant, asymmetrical overall image 10 would result. However, in accordance with the process of the present invention, the base image 26 is manipulated and the manipulated base image is inserted into each of the quadrants 12-18 in order to create an overall symmetrical image which is pleasant to the eye.

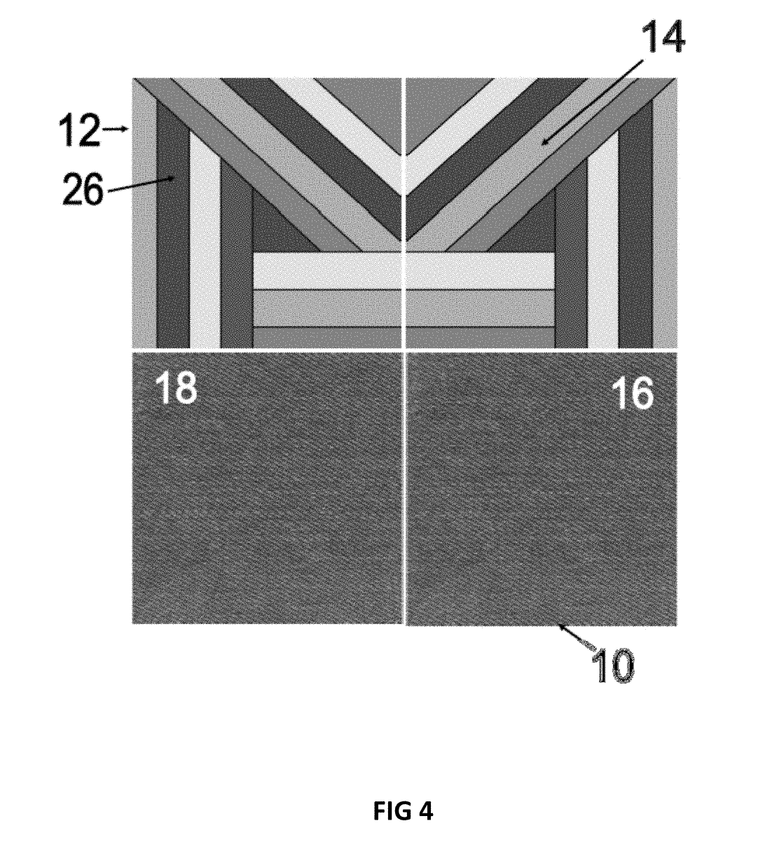

With reference now to FIGS. 1 and 4, a mirror image of the base image 26 is created in the upper right quadrant 14. This may be visualized by flipping the base image 26 from left to right in order to occupy quadrant 14.

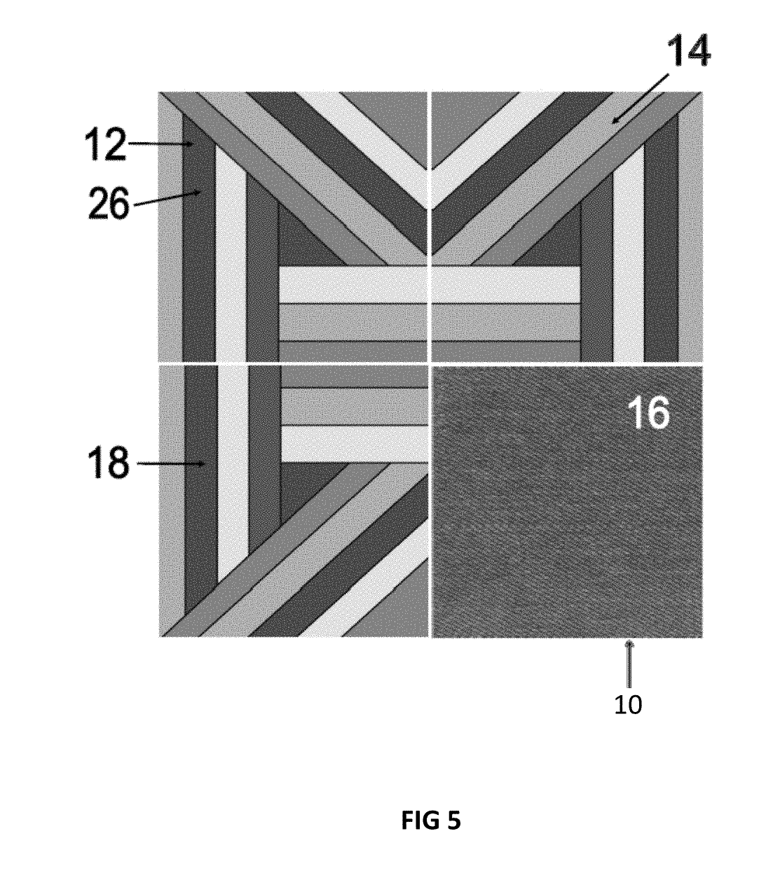

With reference now to FIGS. 1 and 5, the base image 26 in quadrant 12 is again replicated as a mirror image into quadrant 18, as illustrated. This can be visualized by flipping the base image 26 in quadrant 12 from top to bottom such that the mirror image of the base image is created in quadrant 18.

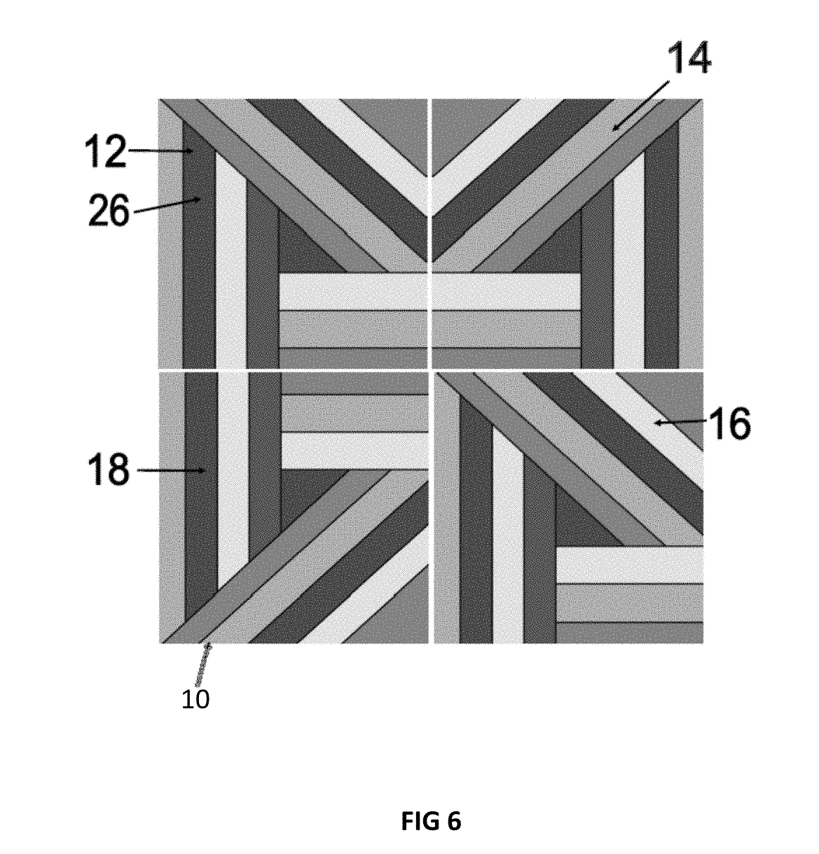

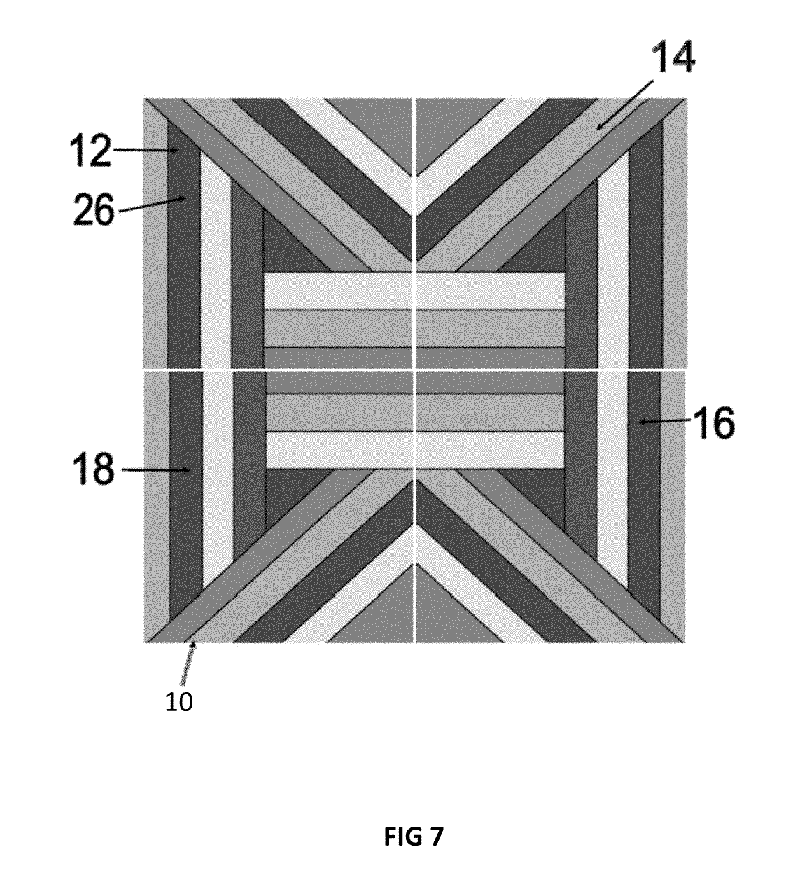

With reference now to FIGS. 1, 6 and 7, in order to complete the image 10, the original base image 26 is inserted into quadrant 16, as illustrated in FIG. 6. It will be seen that the overall image 10 is not symmetrical and is unpleasant. Thus, as illustrated in FIGS. 1 and 7, the image is rotated one hundred eighty degrees, as illustrated in FIG. 7, to create a pleasant, symmetrical overall image 10.

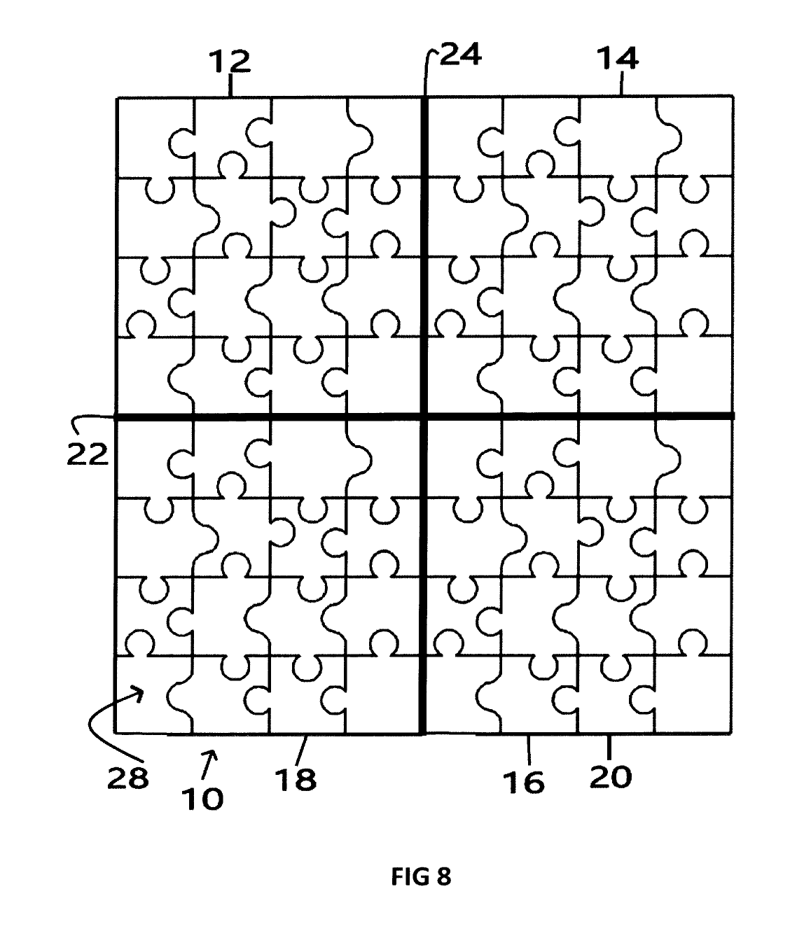

With reference now to FIG. 8, the overall image 10 is cut into individual jigsaw puzzle pieces 28 having a variety of configurations and shapes. However, the outer perimeter edge 20 is kept straight or constant, as are the inner horizontal 22 and vertical 24 edges. In essence, in the illustrated example, each quadrant 12, 14, 16, and 18 has a perimeter edge defined by the inner, horizontal boundary 22, the vertical inner boundary 24 and two perimeter edges defined by the overall outer perimeter 20. What is important is that each of the quadrants 12-18 has a pre-defined perimeter boundary which, even when rotated, aligns with the perimeter boundaries of the adjacent quadrants.

What has been illustrated and described thus far with respect to FIGS. 1-8 is the creation of a single image 10 for a puzzle having a plurality of individual jigsaw puzzle pieces 28 which can be assembled to create the image illustrated in FIGS. 1 and 7. However, in accordance with the present invention, the very same jigsaw puzzle pieces 28 comprising the original puzzle image 10 can also be used to create other images which are different than the image 10 illustrated in FIGS. 1 and 7, but which are symmetrical.

It will be understood by those skilled in the art of the present invention that the original base image 26 may be disposed in each of the quadrants 12, 14, 16 and 18. The mirror images in quadrants 14 and 18 can be created by flipping and rotating the image. However, the base image 26 disposed in quadrant or section 16 is merely rotated and is not flipped in order to create the end resulting image 10, as illustrated in FIG. 7.

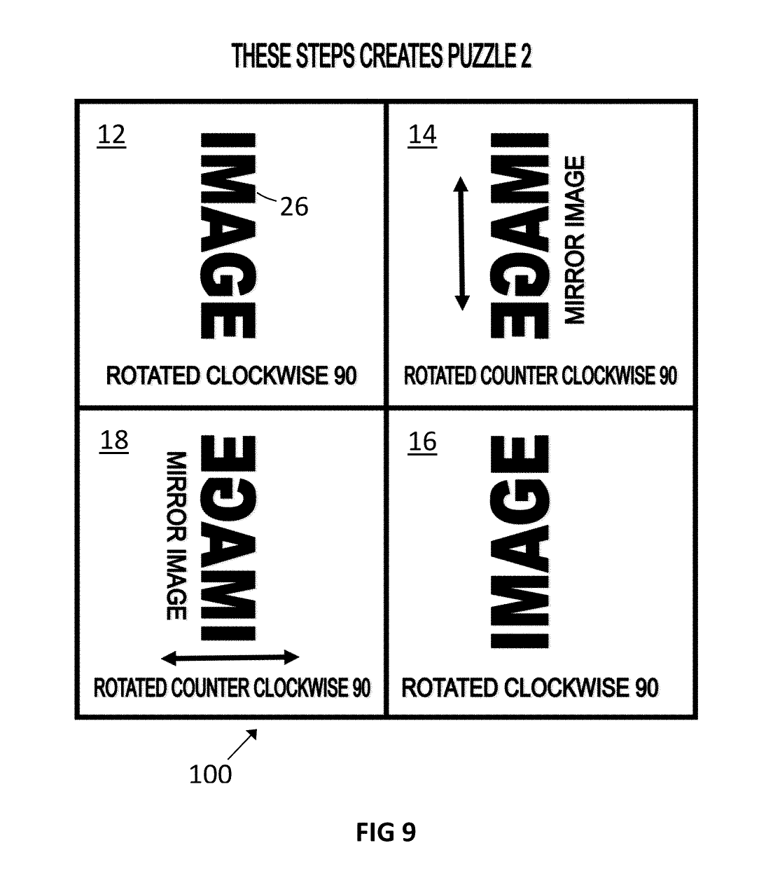

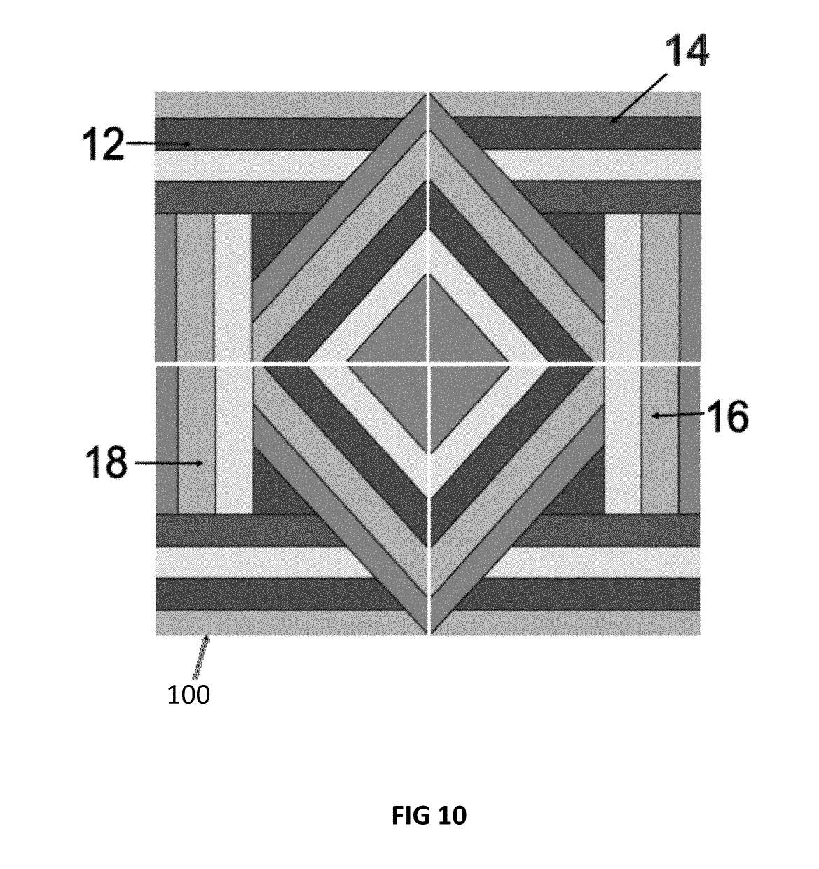

With reference now to FIGS. 9 and 10, as mentioned above, the multiple jigsaw puzzle pieces 28 formed in the original end array image 10, such as illustrated in FIG. 7, can be used to create other end array images or puzzles utilizing the same jigsaw puzzle pieces 28. FIGS. 9 and 10 illustrate the process for creating a second puzzle or end resulting image 100. The image orientations illustrated in FIG. 1 are merely rotated to create a second symmetrical image 100 or puzzle.

More particularly, with reference to FIG. 9, the base image 26 in quadrant 12 is rotated ninety degrees clockwise from its position in FIG. 1 to its position in FIG. 9. Similarly, the image in quadrant 16 of FIG. 1 is rotated clockwise ninety degrees to achieve the resultant image alignment in quadrant 16 in FIG. 9.

The mirror images in quadrants 14 and 18 of the original base image 26 are each rotated counter-clockwise ninety degrees to achieve the resultant arrangement of FIGS. 9 and 10. It will be seen that the resultant puzzle image in FIG. 7 is much different than the resultant puzzle image 100 in FIG. 10, yet they are both symmetrical and aesthetically pleasing.

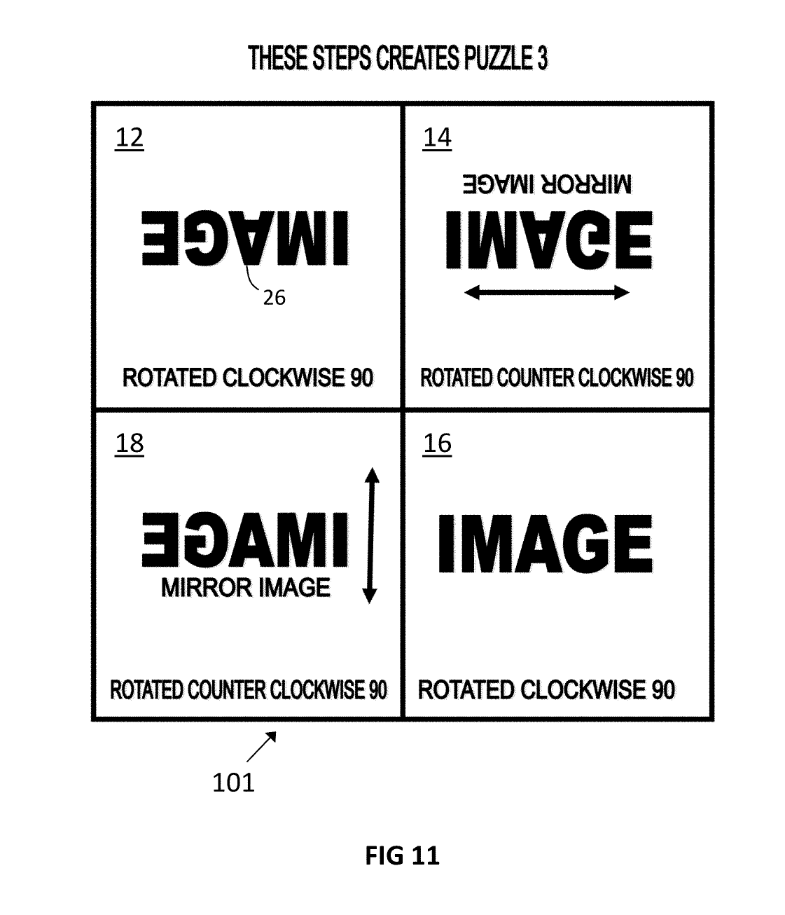

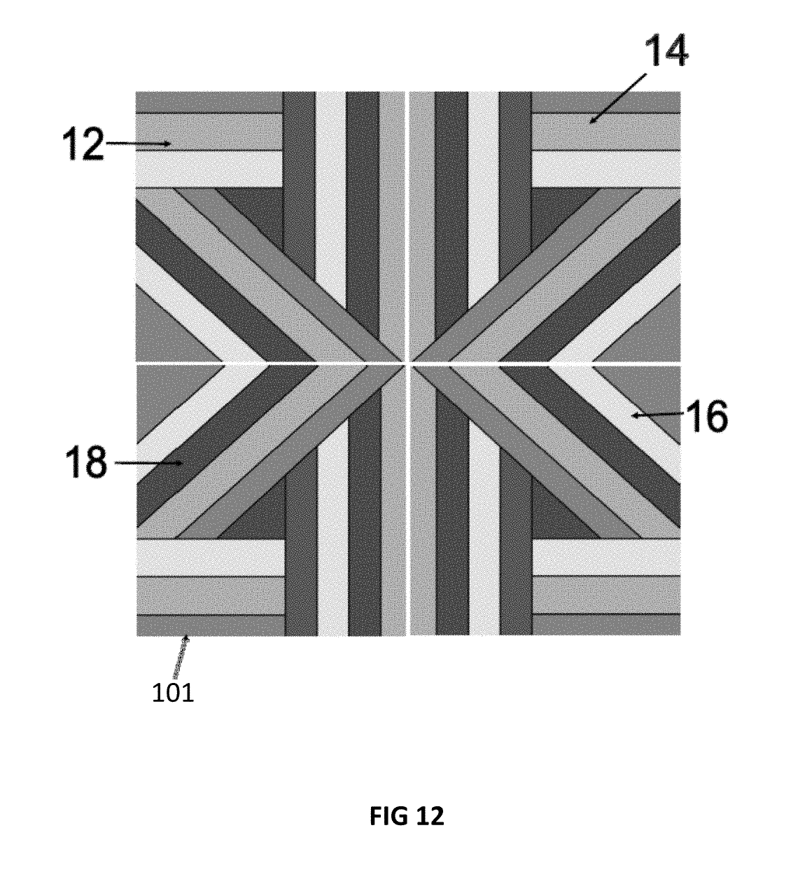

With reference now to FIGS. 11 and 12, the process and method for creating a third puzzle image 101 is shown. With reference to FIG. 11, the images 26 in quadrants 12 and 16 are rotated clockwise ninety degrees. The images in quadrants 14 and 18 of FIG. 9 are each rotated ninety degrees counterclockwise. The resultant puzzle image 101 is shown in FIG. 12. It will be seen that this resultant puzzle image 101 is different than the end resultant puzzle images 10 of FIG. 7 and 100 of FIG. 10, but once again is symmetrical and pleasing to the eye. Furthermore, the exact same jigsaw puzzle pieces 28 which form the original puzzle image 10 (FIG. 1) can be used to create the second and third puzzle images 100 and 101 (FIGS. 9 and 11).

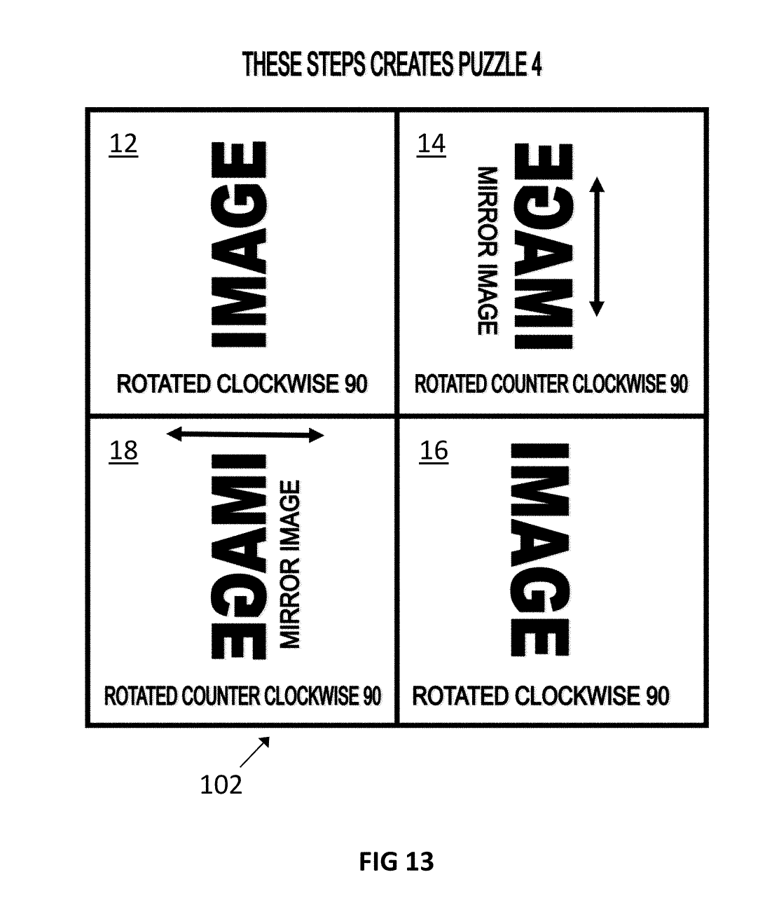

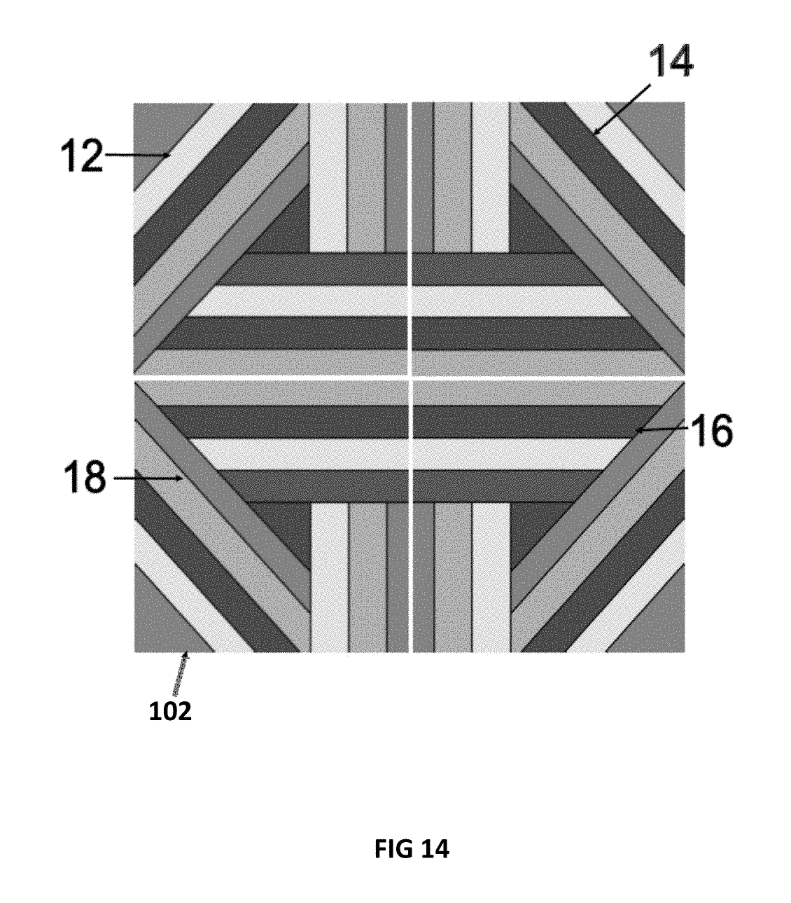

With reference now to FIGS. 13 and 14, the process and method in accordance with the present invention of creating a fourth final puzzle image 102 from the same base image 26 is shown. The images 26 in quadrants 12 and 16 of the third puzzle design, illustrated in FIG. 11, are each rotated clockwise ninety degrees. The mirror image images in quadrants 14 and 18 of FIG. 11 are each rotated counter-clockwise ninety degrees. FIG. 14 illustrates the resultant, final puzzle image 102, which is different than the other puzzle images 10, 100 and 101, but yet is symmetrical and pleasing to the eye. Once again, the same jigsaw puzzle pieces 28 created in the first puzzle design 10 is used to create this final puzzle design 102 as well. This is possible due to the incorporation of inner boundary edges which align with one another, even when the images of the various quadrants are rotated with respect to one another. The use of a 2×2 arrangement of quadrilateral quadrants enables a quadrilateral outer perimeter 22 and bisecting inner perimeter boundaries 22 and 24, even when the images within each quadrant 12-18 are rotated with respect to one another to create the various final puzzle images 10, 100, 101 and 102.

Thus, in accordance with the present invention, a single base image 26 can be manipulated and placed within quadrants and flipped, so as to create a mirror image, and/or rotated in order to create new symmetrical abstract images which enables a single set of jigsaw puzzle pieces 28 to create multiple images, such as the foregoing described and illustrated four puzzle images 10, 100, 101 and 102.

It is also contemplated by the present invention that the single base image 26 be cut or otherwise formed into quadrants for the purposes of creating new symmetrical abstract images, by manipulating each portion of the image in each of the quadrants, such as by rotating or flipping the images, such as described above.

In this manner, the purchase of a single puzzle actually yields multiple end resulting puzzles which can be created from the same puzzle pieces, enabling the same puzzle to be recreated multiple times, such as four times, to create multiple (four) end resulting puzzle images, which provides increased excitement and challenge for the puzzle assemblers.

It is also contemplated by the present invention that a different base layer image be used on each side of the jigsaw puzzle substrate, so as to effectively double the number of puzzles that can be created using the same jigsaw puzzle pieces. Moreover, having an image on the front and back sides of each jigsaw puzzle piece presents a further challenge to the assemblers of the jigsaw puzzle.

In accordance with another embodiment of the present invention, images are created to form puzzle sets, wherein, in one instance the same pieces may be utilized to create five different images. In another instance, both sides of the puzzle pieces are utilized, the two images may be utilized to create double the puzzles, such as ten different puzzles. In yet another instance, a triangular quadrant of the puzzle is reproduced four times in each quadrant and packaged separately to allow creation of various puzzles relating to the selected image.

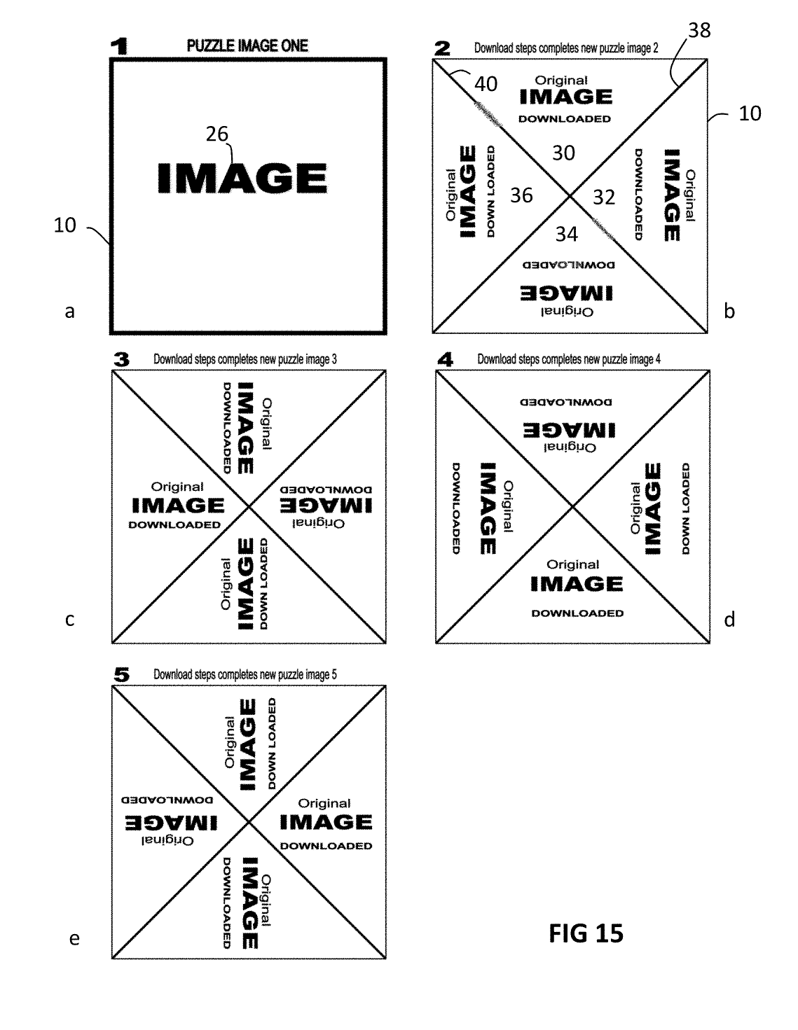

With reference now to FIG. 15, an original, base image 26 is shown in FIG. 15a. This original image can be used to create a single puzzle, or another image may be placed on the backside of the puzzle substrate so as to create two puzzle images, and thus two puzzles with the same jigsaw puzzle pieces.

With reference now to FIG. 15b, in accordance with the present invention in order to create a new puzzle image, a section of the original image 26 is taken. An area 10 which will define the overall boundaries of the resulting image and puzzle is formed into multiple sections, such as the illustrated triangular sections 30-36, wherein bisecting boundary lines 38 and 40 from each corner of the generally rectangular area 10 form the triangular quadrants 30-36. The section of the original image 26 is placed within each quadrant 30, 32, 34 and 36, ensuring that the image does not cross boundaries 38 and 40, so as to reside completely within each triangular quadrant 30-36.

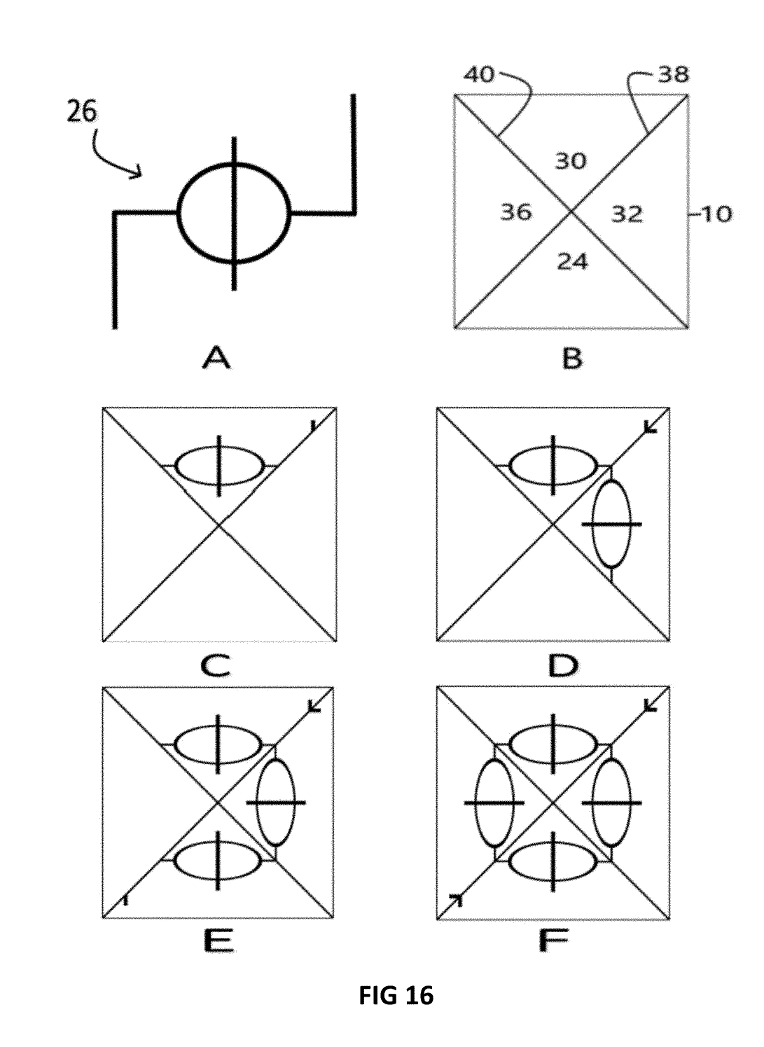

This is shown in FIG. 16, wherein a portion of image 26 in FIG. 16a is placed within quadrant 30 of FIG. 16b, resulting in the image of FIG. 16c. The same image is inserted into all of the quadrants 30-36, as illustrated in FIGS. 16c-f, until the final image is created, as illustrated in FIG. 16f. It will be seen that FIG. 16f resembles somewhat the original image 26, but does not include the entire image and is a symmetrical abstract image derived from the original image 26. Thus, one puzzle could comprise the image of FIG. 16a, while another puzzle could comprise the image of FIG. 16f and thus be similar and related to one another, but different.

With reference again to FIG. 15, the section of the original image 26 used in FIG. 15b could then be manipulated within each quadrant 30-36, such as by rotating the image and/or creating mirror images of the image section. For example, in FIG. 15c a third puzzle image is shown, wherein the original section image in each quadrant 30-36 of FIG. 15b has been rotated clockwise ninety degrees, so as to create another symmetrical, abstract puzzle image. Rotating each of the images another ninety degrees results in the overall puzzle image of FIG. 15d. Rotating each of the images yet another ninety degrees results in the final puzzle arrangement and image illustrated in FIG. 15e. Thus, five puzzle images are created from the single original image 26, which are all different from one another, yet symmetrical, interesting and pleasing to the eye and related to the initial base image 26.

It is important when forming the jigsaw puzzle pieces that the cut lines do not extend beyond the outer perimeter boundary or the inner boundaries 38 and 40. This enables the same jigsaw puzzle pieces to be utilized in creating different overall puzzle images which vary from one another, such as by the image in each quadrant 30-36 being rotated with respect to one another. The four quadrants 30-36 are of the same size and configuration, enabling this feature.

With reference again to FIG. 16, it can be seen that the section of original image 26 in FIG. 16a is taken from a generally triangular section from approximately the upper right and left corners to a midpoint below or at the base of the image 26. This triangular section is of a different size and configuration than the equilateral triangular sections 30-36. Thus, it will be noted that the resulting image in FIG. 16c is distorted somewhat when the selected section taken from the original image is pasted into the quadrant. This further creates a desirable modification of the original image so as to create a symmetrical, abstract image which somewhat resembles the original image 26.

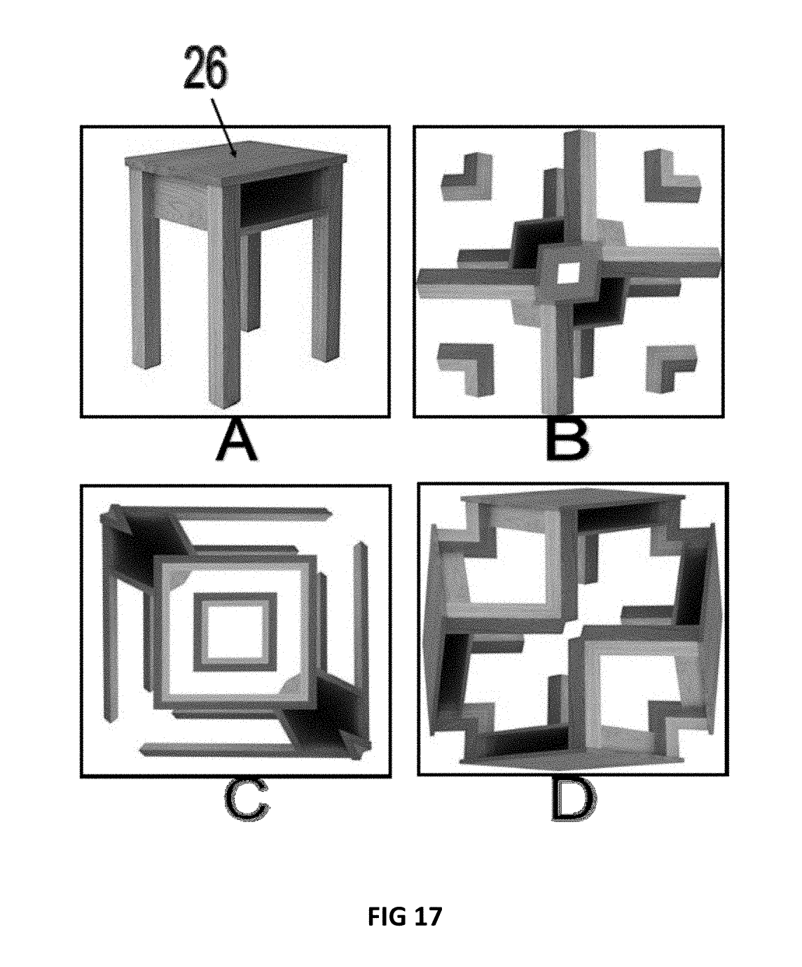

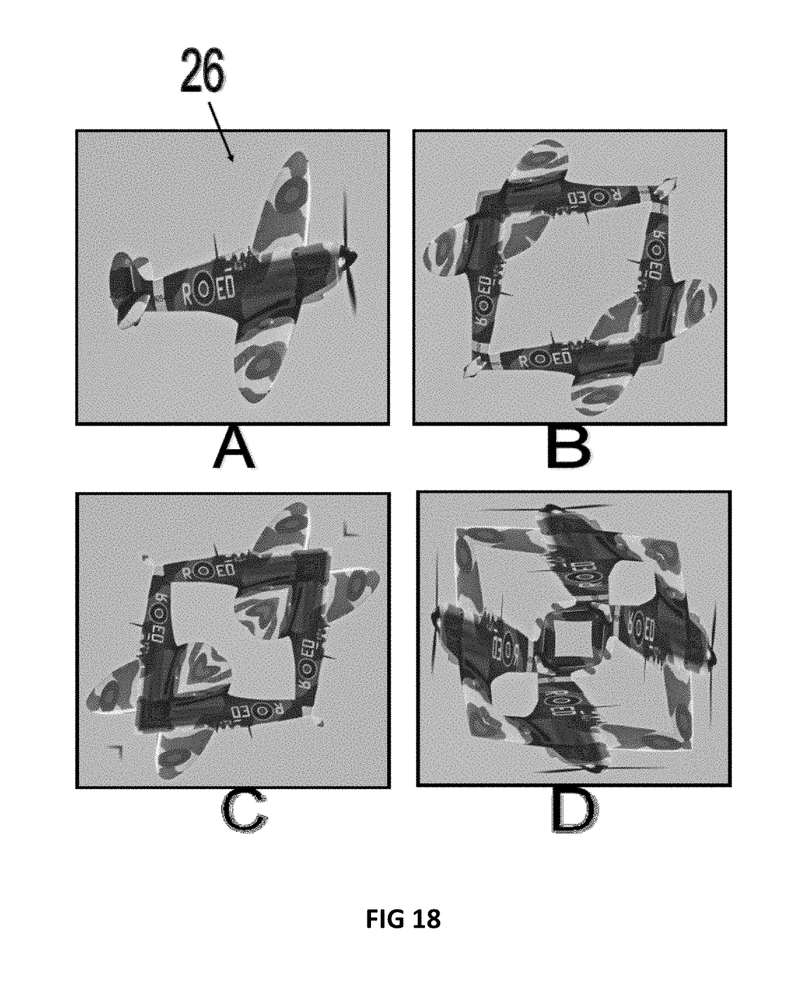

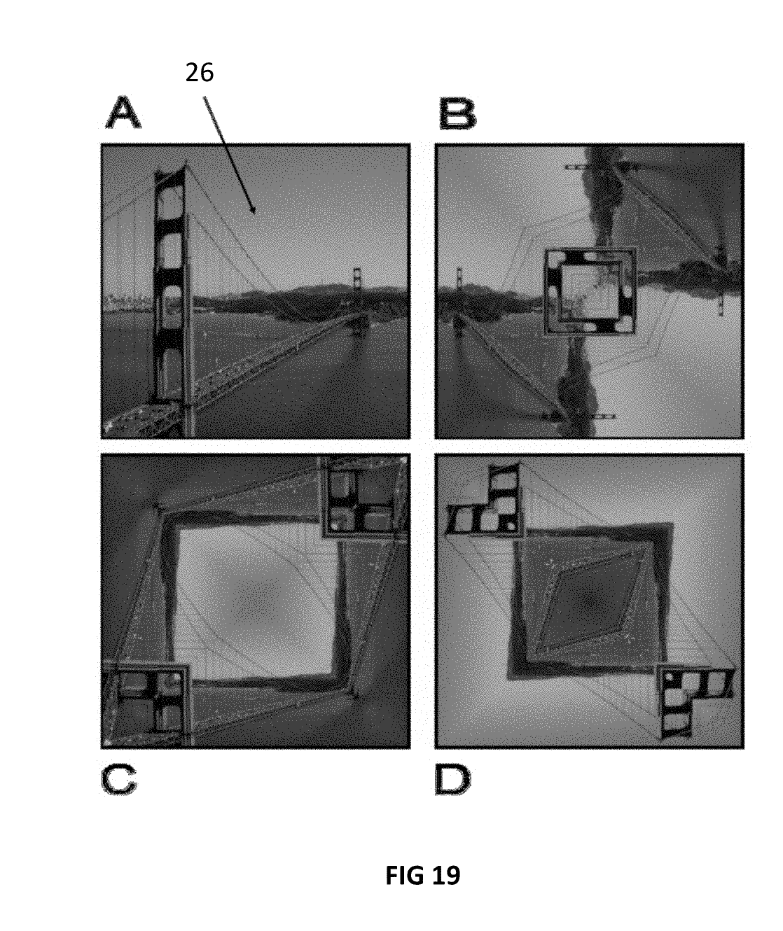

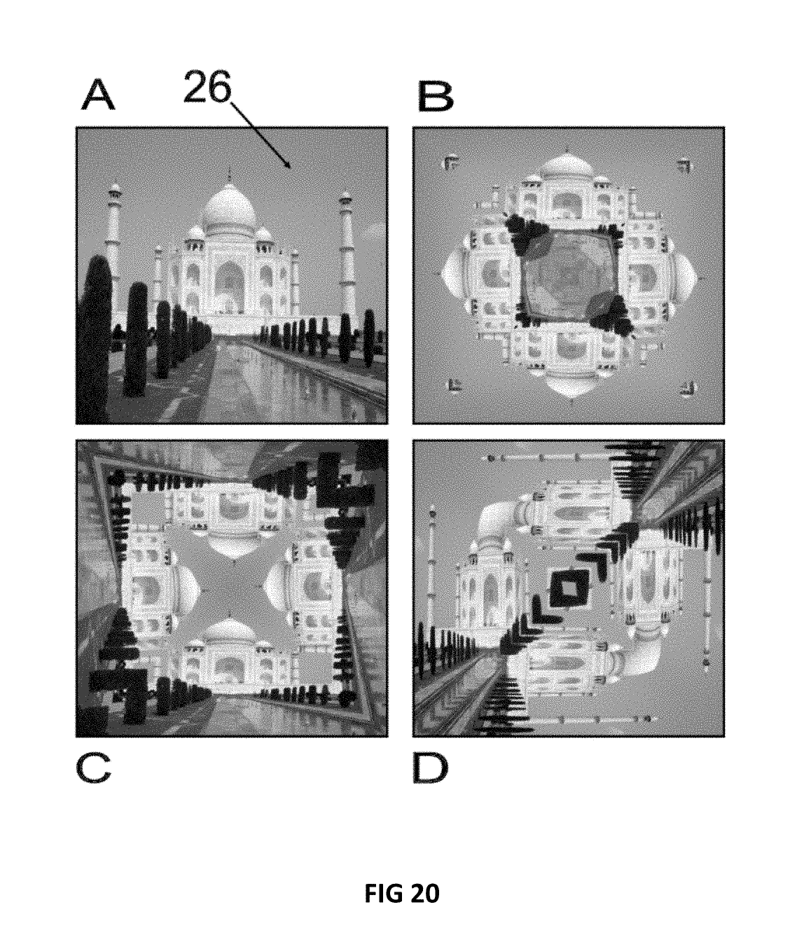

With reference now to FIG. 17, an original image 26 is shown, a section of which is used to create the other images illustrated in FIGS. 17b-d, which would create their own puzzles. This is also illustrated in FIGS. 18-20, wherein original image 26 is sectioned and a portion thereof is used to fill in areas or quadrants, such as the aforementioned and illustrated triangular quadrants, so as to create symmetrical, yet abstract and interesting corresponding images which can be used for different puzzles.

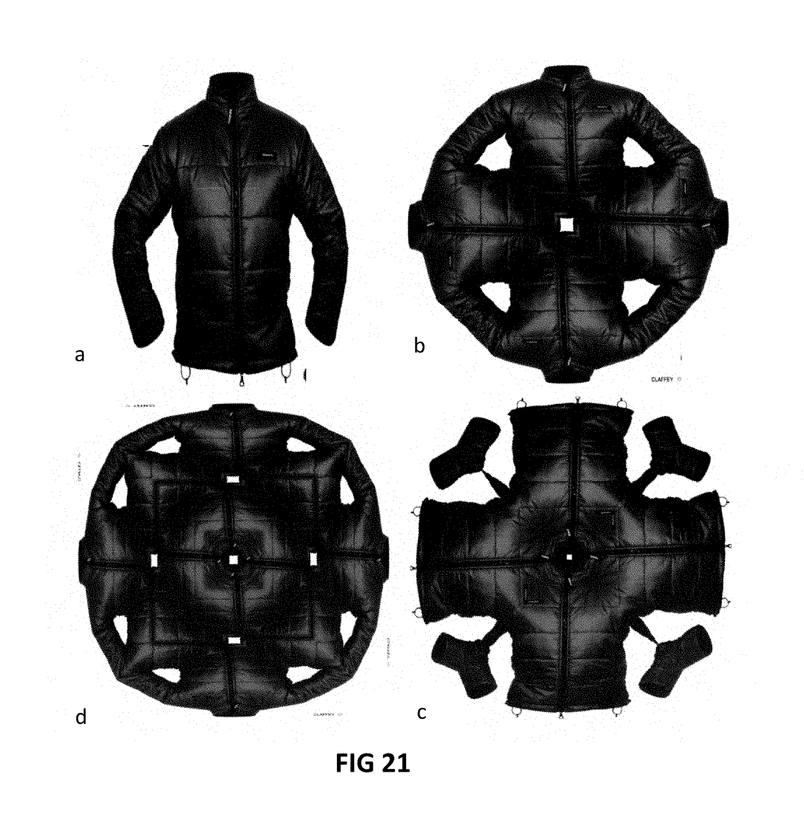

With reference now to FIG. 21, an original image 26 is shown in FIG. 21a. Taking a generally triangular section from the upper left and right corner of the image towards a midsection at the base of the image and inserting such image into each quadrant results in the image of FIG. 21b. Conversely, taking a section of the image from the lower portion of the image 26 in FIG. 21a towards the top and inserting into each quadrant results in the image of FIG. 21c. FIG. 21d is a combination of images into each quadrant. It will be seen that each of the alternate created images in FIGS. 21b-d is a symmetrical, somewhat abstract version of the original version 26. Each of these images illustrated in FIGS. 21a-d can represent its own puzzle to be solved and assembled.

There could be multiple packages of jigsaw puzzle pieces within each box providing the puzzles, each package of puzzle pieces corresponding to each one of the original or modified and created corresponding images. In the puzzles illustrated in FIGS. 17-21, there could be up to four such packages of jigsaw puzzle pieces. However, as mentioned above, a second image could be imprinted upon the back surface of the original image so as to effectively double the number of puzzles which can be created with the totality of the jigsaw puzzle pieces within the container or product packaging.

The foregoing methods can also be used to create various art patterns for many type of photograph or print images which can be utilized, for example, in fabric designs, clothing patterns, etc. That is, an original image, or a portion thereof, can be placed into quadrants and manipulated to create different symmetrical designs within a given area. These resulting designs can be used as art patterns in a wide variety of applications.

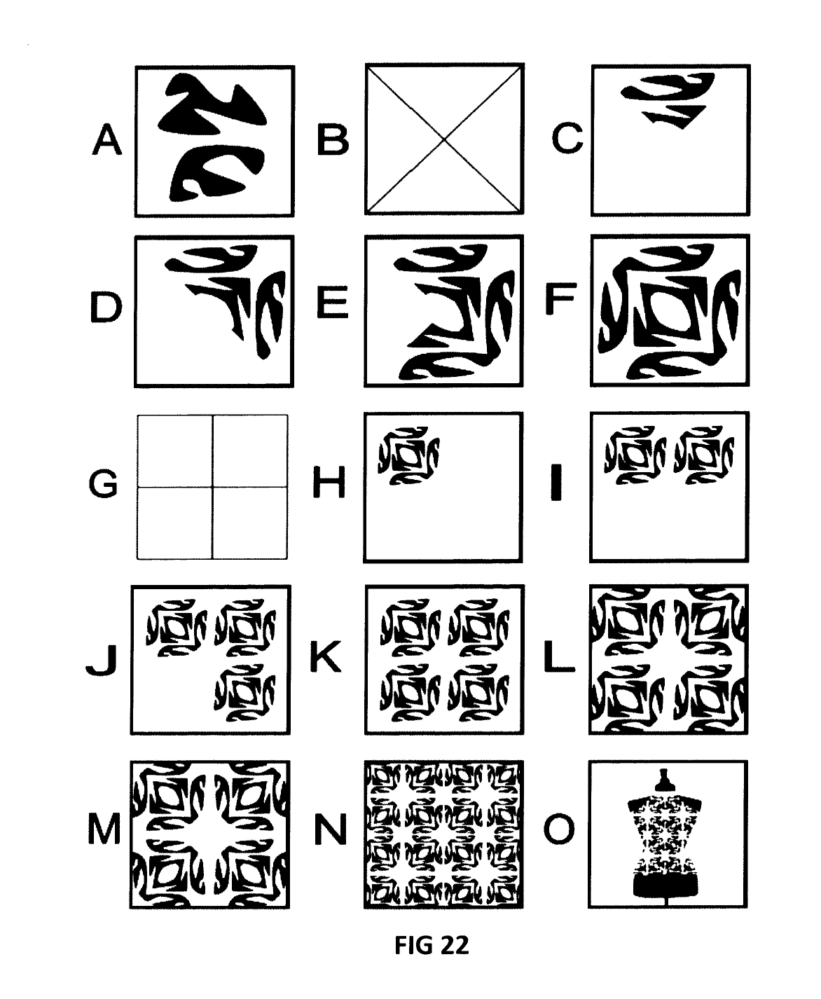

With reference now to FIG. 22, an original, base image is illustrated in FIG. 22a. This image can be any type of photograph or print image. An area is divided into sections, such as the illustrated triangular quadrants in FIG. 22b. A section of the original image (FIG. 22a) is inserted into one of the quadrants of FIG. 22b. This is repeated (FIGS. 22d-f) to create a preliminary image. This preliminary image illustrated in FIG. 22f could be utilized as an art pattern for fabric designs, clothing patterns, etc.

However, in one embodiment of the invention, this preliminary image, based in part or whole from the original image (FIG. 22a) is again replicated, as described above, such as by inserting the image into sections or quadrants of an array, as illustrated in FIGS. 22g, h, i, j and k. It can be seen that the pattern in FIG. 22k is not symmetrical. Thus, one or more of the images in one or more of the quadrants is rotated and/or flipped to create mirror images, as described above, to create a symmetrical secondary image. Thus, for example, the images in the upper right-hand and lower left-hand quadrants are rotated clockwise ninety degrees to achieve a symmetrical secondary image in FIG. 22m.

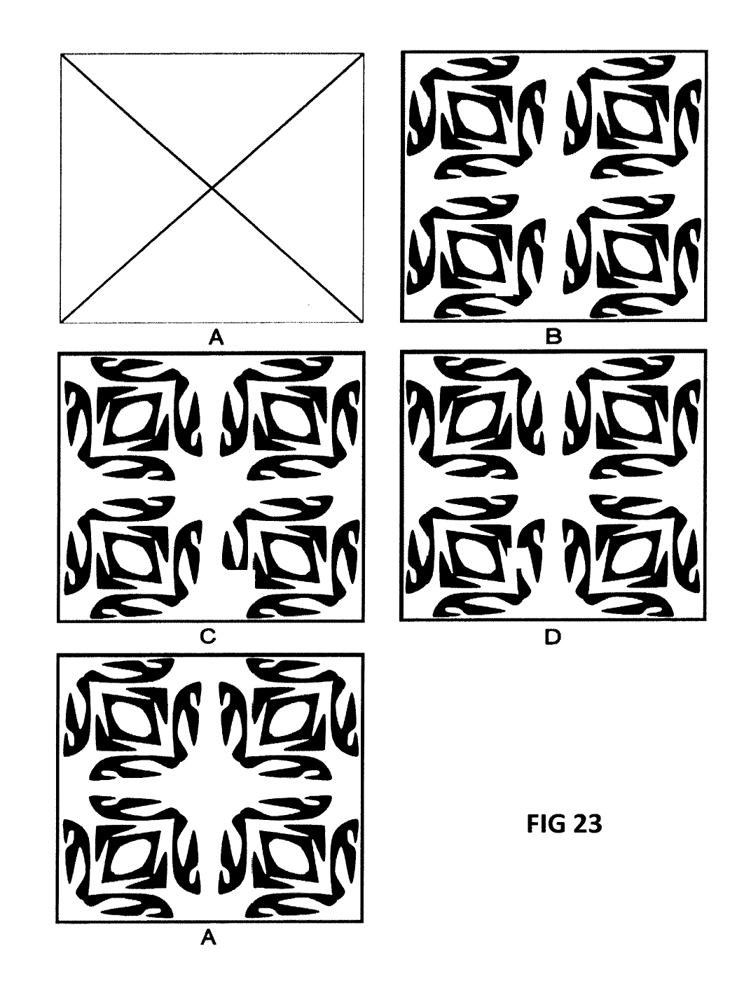

With reference now to FIG. 23, the quadrant or 2×2 array of FIG. 22g is replicated in FIG. 23a. Placement of the secondary image of FIG. 22f is placed into each quadrant, as illustrated in FIGS. 221 and 23b. However, in the case of FIGS. 23c and d, the images are rotated differently so as to create a different secondary design or pattern in FIG. 23, which is still symmetrical, but is different than the pattern or image illustrated in FIGS. 22m and 23e. These secondary designs can be used in the creation of the fabric pattern or the like.

However, the combination of the images or patterns in FIG. 23d and FIG. 23e can be used together, as illustrated in FIG. 22n to create a fabric design, such as for a shirt, as illustrated in FIG. 22o, which is interesting, has symmetry, and corresponds abstractly with the original image in FIG. 22a.

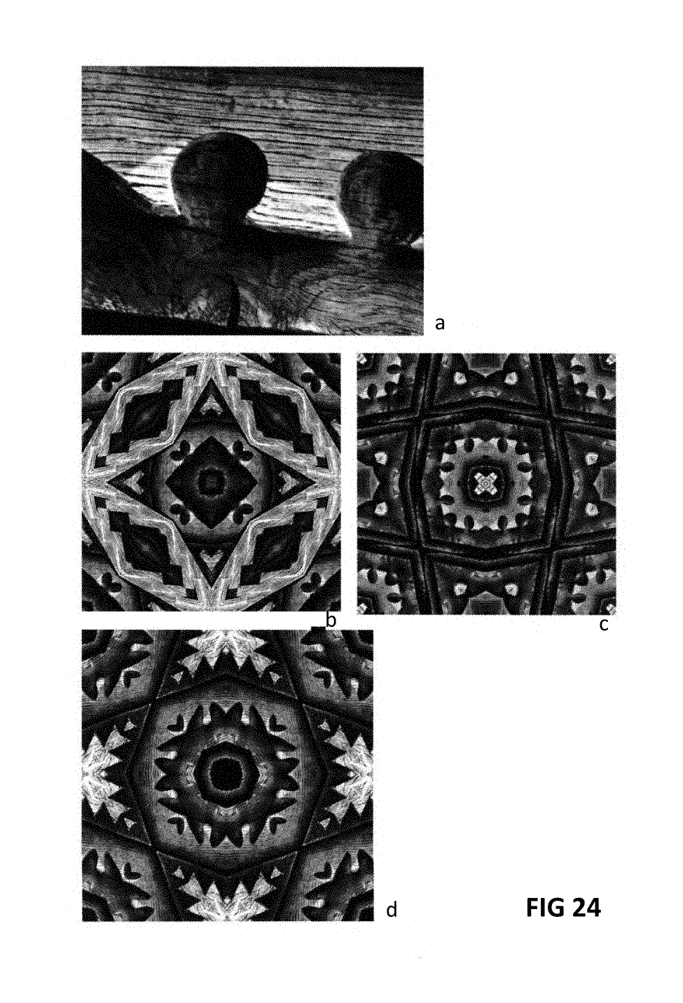

With reference now to FIG. 24, an enlarged portion of a photograph is illustrated in FIG. 24a. Utilizing the methods and concepts of the invention described above, different patterns can be created, as illustrated in FIGS. 24b-d. All of these patterns or designs are derived, in whole or part, from the original photograph in FIG. 24a. However, the designs illustrated in FIGS. 24b-d are much more intricate and interesting than the original photograph in FIG. 24a and capable of being used for a fabric design, clothing patterns, etc.

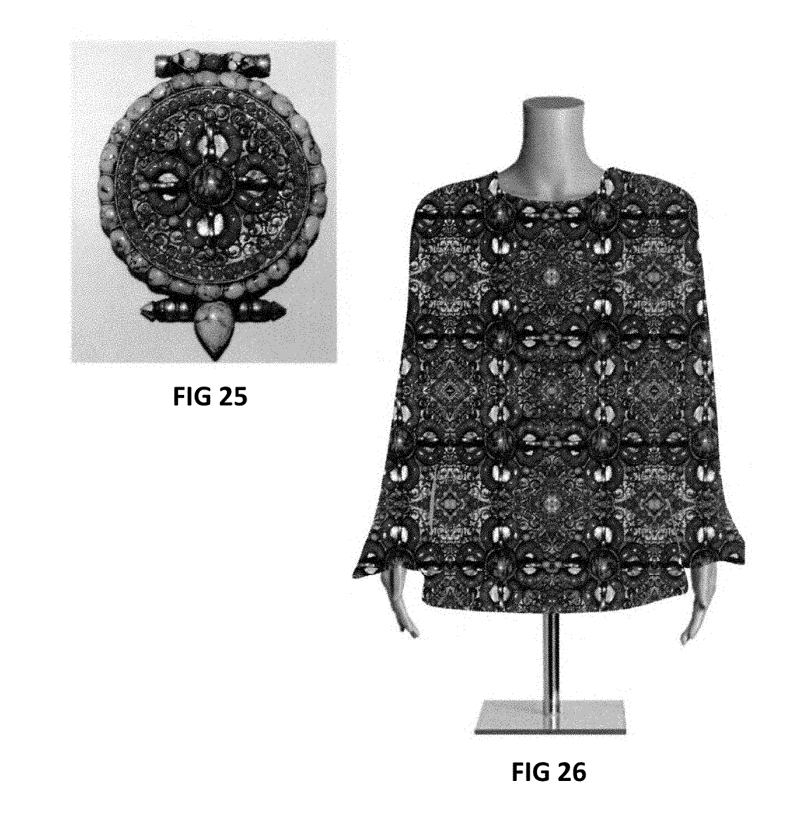

With reference now to FIGS. 25 and 26, the image may be comprised of a photograph of a real object, such as the illustrated jewelry, or it could also be photographs of buildings, common objects, etc. which may be readily recognizable or interesting in and of themselves. Utilizing the methods of the present invention, a fabric pattern, such as illustrated in FIG. 26, could be created which has similarities to the original photograph of the object, but are not merely repeated reproductions of the photograph of the object.

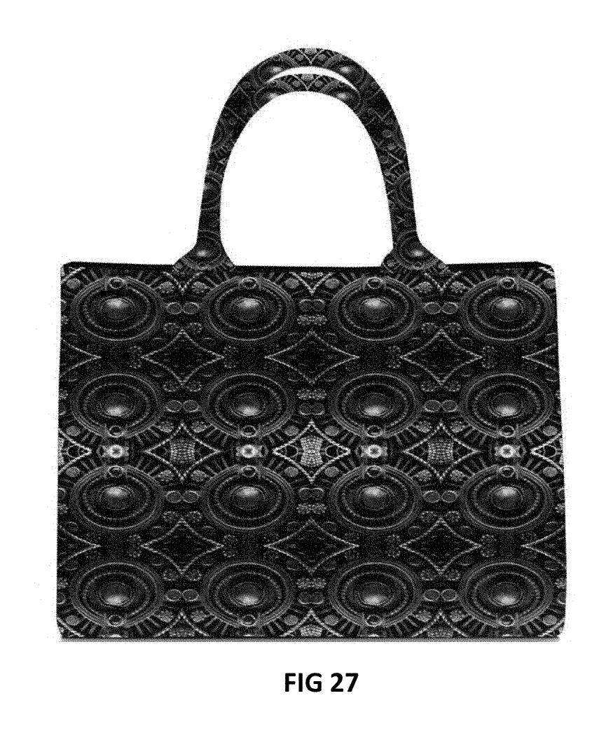

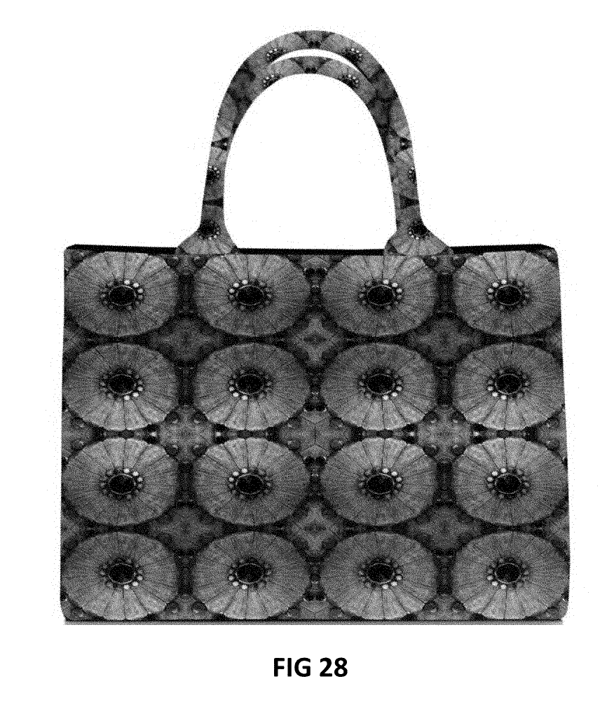

FIGS. 27 and 28 illustrate hand purses having designs created in accordance with the present invention.

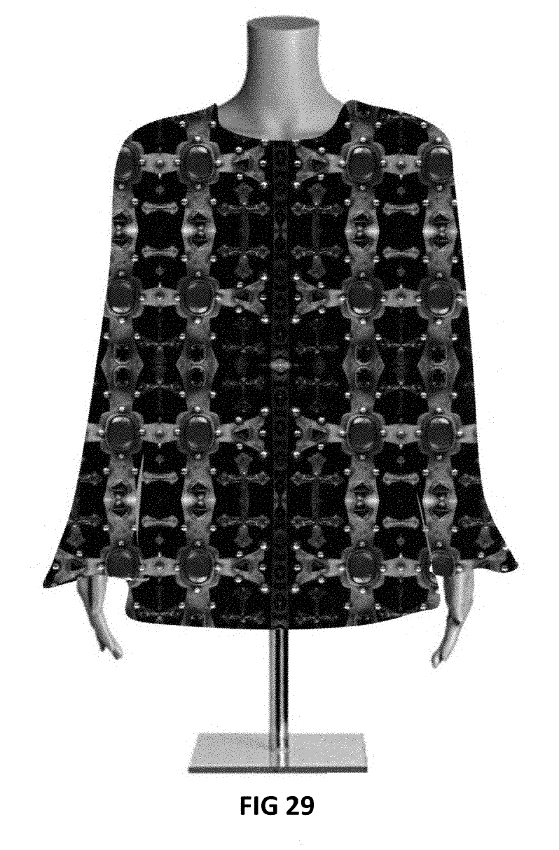

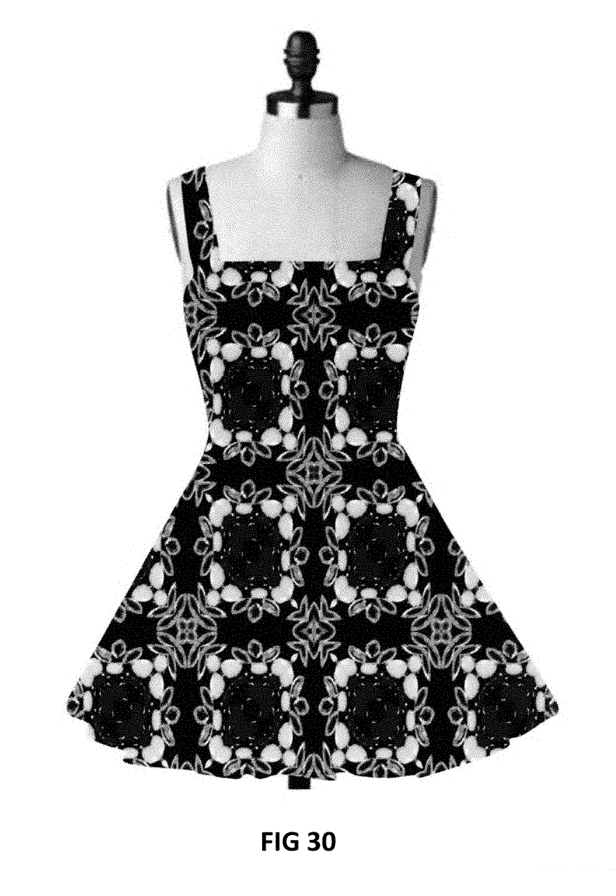

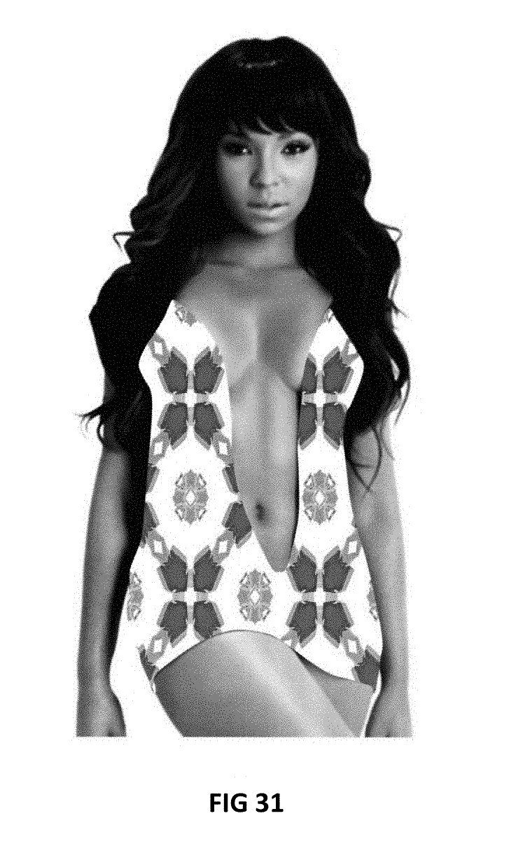

FIGS. 29-31 illustrate fabric designs and clothing patterns created utilizing the method and teachings of the present invention.

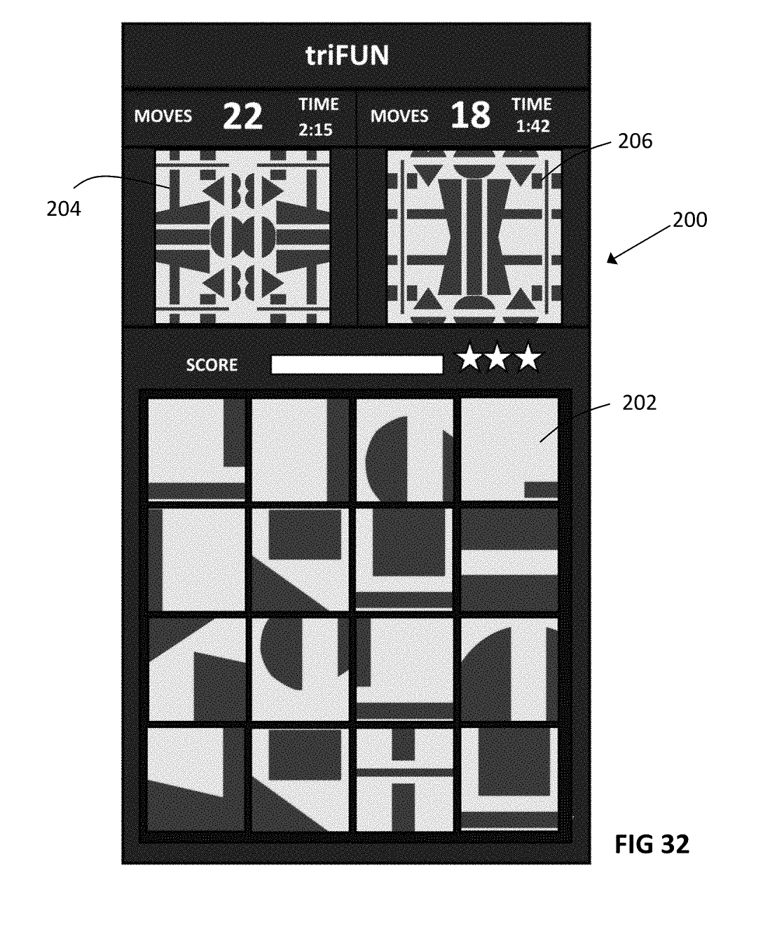

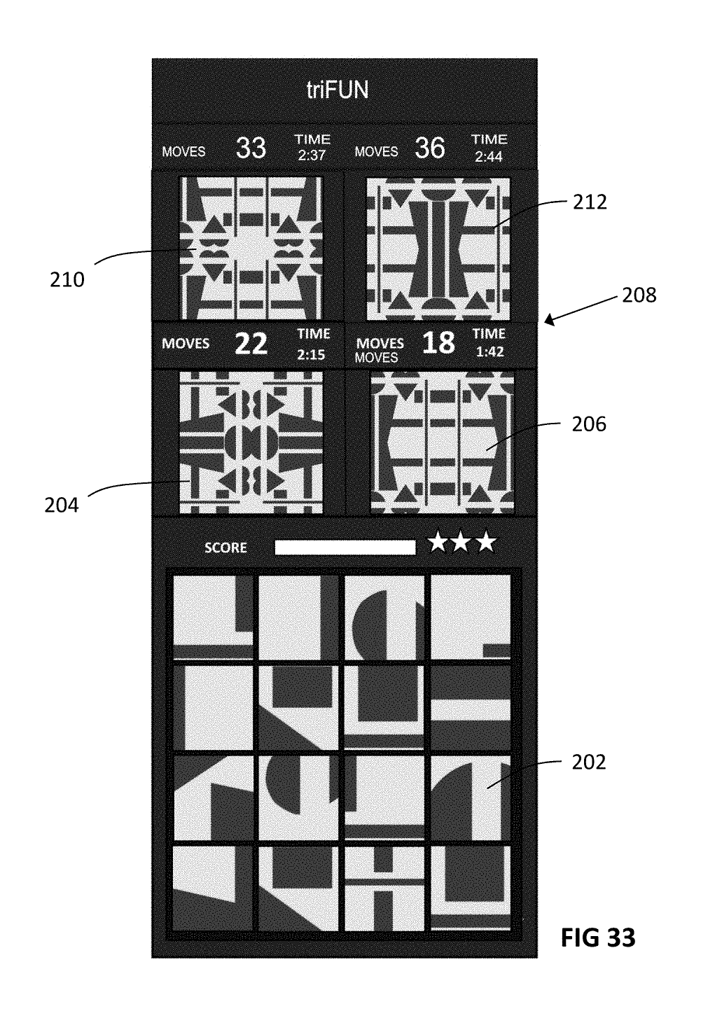

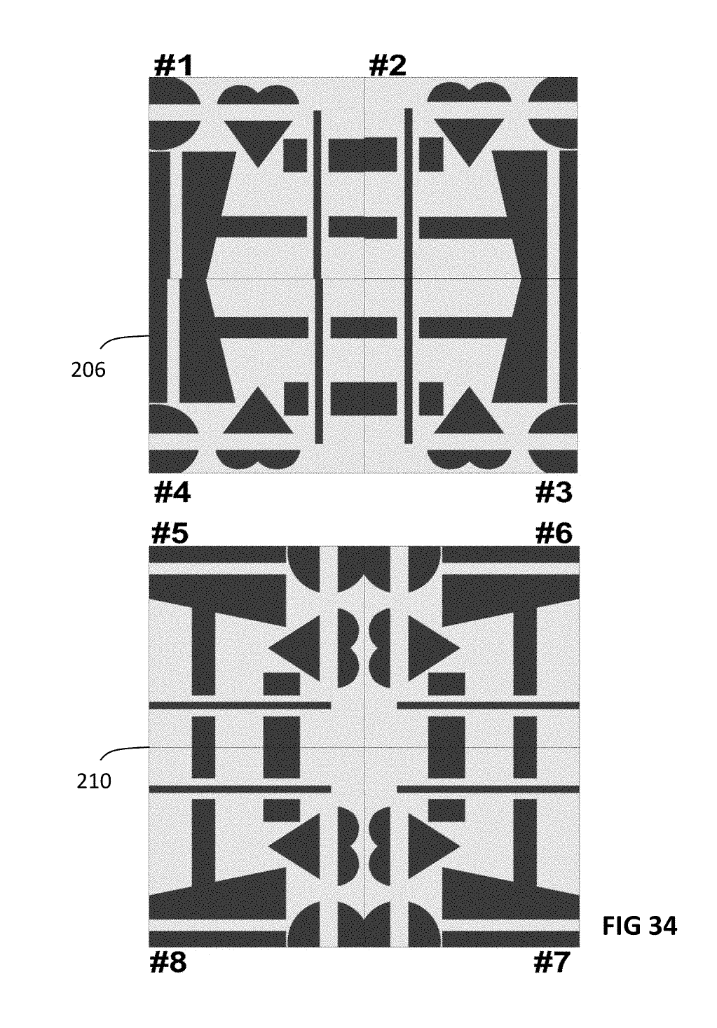

FIGS. 32 and 33 illustrate the manner in which the aforementioned four-in-one jigsaw puzzles may be applied in a puzzle app for a mobile device. In this regard, FIG. 32 illustrates a screen shot of a mobile device 200 wherein 16 puzzle pieces 202 are shown in the lower portion and two exemplary puzzles 204 and 206 are illustrated in an upper portion. Because the 16 puzzle pieces 202 have been created in accordance with the concepts of the present invention, they may be utilized to create four distinct puzzle images (only two of which are shown in FIG. 32).

In the game shown in FIG. 32, the user drags and orients a selected puzzle piece 202 onto each of the images 204 and 206 until both puzzles have been recreated from the images 202. Note that the images 202 are provided in duplicate, meaning once the first images pulled up and oriented over the images 204 and 206, a second identical puzzle piece will reappear in the same space. The idea behind this game is to solve both puzzles with the least possible moves and in a shortest time.

FIG. 34 illustrates a similar mobile device 208 wherein a lower portion has the same puzzle pieces 202 and above those puzzle pieces four completed puzzle images 204 and 206 (similar to that illustrated in FIG. 32), as well as two additional images 210 and 212.

The concept of the gaming app of FIG. 33 is similar to that illustrated and described in connection with FIG. 32, wherein the puzzle pieces (provided in groups of four) are moved up to the puzzle images 204, 206, 210 and 212 with the goal of solving all of the puzzles with the least possible moves in the shortest time.

FIG. 34 illustrates how quadrants of a first image 206 are manipulated to form a second symmetrical image 210 in accordance with the following steps:

Step 1. Place original image in quadrant #1;

Step 2. Flip image from quadrant #1 horizontal then inserting new image into quadrant #2;

Step 3. Flip image from quadrant #2 vertical then inserting new image into quadrant #3;

Step 4. Flip image from quadrant #3 then inserting new image into quadrant #4;

Step 5. These steps completes the first puzzle design;

Step 6. Rotate right 90 degrees image from quadrant #1 then insert new image into quadrant #5;

Step 7. Rotate left 90 degrees image from quadrant #2 then insert new image into quadrant #6;

Step 8. Rotate right 90 degrees image in quadrant #3 then place new image into quadrant #7;

Step 9. Rotate left 90 degrees image in quadrant #4 then insert new image into quadrant #8;

Step 10. These steps complete the 2nd puzzle design.

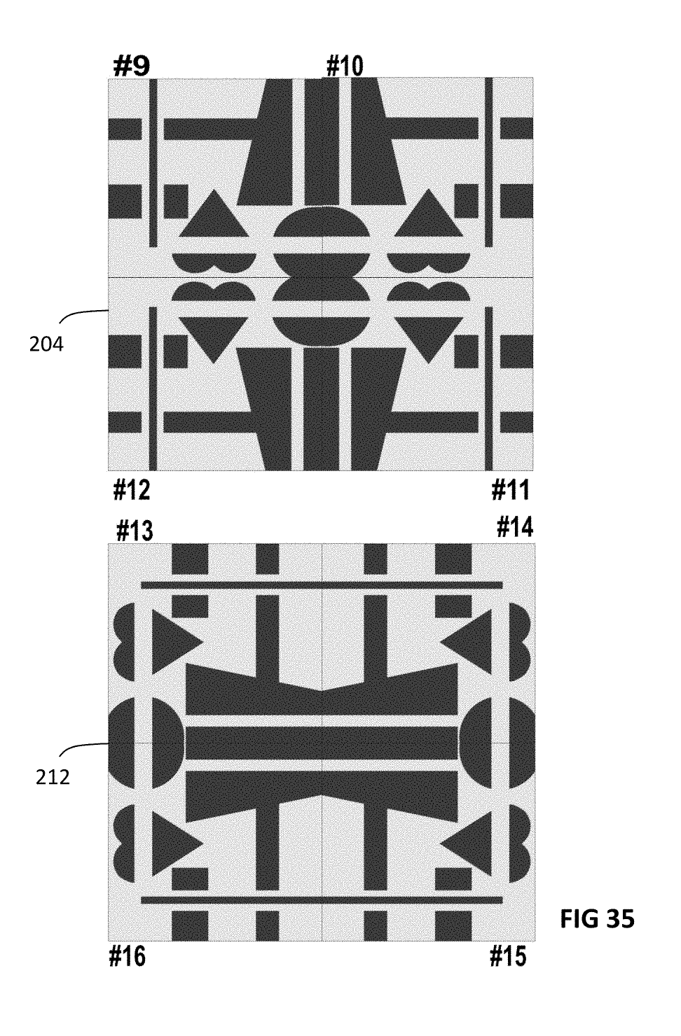

FIG. 35 illustrates further steps required from manipulating images found in FIG. 34 to create a third puzzle design 204 and fourth puzzle design 212 as follows:

Step 11. Rotate right 90 degrees image from quadrant #5 then insert new image into quadrant #9;

Step 12. Rotate left 90 degrees image from quadrant #6 then insert new image into quadrant #10;

Step 13. Rotate right 90 degrees image from quadrant #7 then insert new image into quadrant #11;

Step 14. Rotate left 90 degrees image from quadrant #8 then insert new image into quadrant #12;

Step 15. These step completes the 3rd puzzle design;

Step 16. Rotate right 90 degrees image from quadrant #9 then insert new image into quadrant #13;

Step 17. Rotate left 90 degrees image from quadrant #10 then insert new image into quadrant #14;

Step 18. Rotate right 90 degrees image in quadrant #11 then place new image into quadrant #15;

Step 19. Rotate left 90 degrees image in quadrant #12 then insert new image into quadrant #16;

Step 20. These steps complete the 4th puzzle design.

Although several embodiments have been described in detail for purposes of illustration, various modifications may be made without departing from the scope and spirit of the invention.

What is claimed is:

1. A process for creating a symmetrical art pattern from an asymmetrical base image, comprising the steps of:
setting a shape and outer perimeter of the symmetrical art pattern, defined by an array of similarly shaped sectioning areas;
attaching an asymmetrical base image onto a first sectioning area;
manipulating the asymmetrical base image to create one or more manipulated images; and
attaching the one or more manipulated images onto a second and any additional sectioning areas, to create the overall symmetrical art pattern.

2. The process of claim 1, wherein each similarly shaped sectioning area has a defined perimeter boundary which, when rotated, aligns with the perimeter boundary of an adjacent sectioning area.

3. The process of claim 1, wherein the manipulating step comprises the step of creating a mirror image of the asymmetrical base image.

4. The process of claim 1, wherein the manipulating step comprises the step of rotating the asymmetrical base image.

5. The process of claim 1, wherein the asymmetrical base image comprises a portion of a recognizable article or thing.

6. The process of claim 1, utilized for creating a multiple-in-one jigsaw puzzle, including the step of cutting the array into individual jigsaw puzzle pieces.

7. The process of claim 6, wherein each similarly shaped sectioning area has a defined perimeter boundary which, when rotated, aligns with the perimeter boundary of an adjacent to sectioning area, and wherein jigsaw puzzle pieces within each sectioning area are cut according to the same pattern.

8. The process of claim 6, wherein the array of similarly shaped sectioning areas comprise rectangles.

9. The process of claim 6, wherein a second base image is provided on a back side of the first sectioning area, and the steps of claim 1 are utilized to create a second multiple-in-one jigsaw puzzle on a back side of the symmetrical art pattern.

10. The process of claim 6, wherein the steps of creating a multiple-in-one jigsaw puzzle are accomplished on a mobile electronic device.

11. A process for creating a multiple-in-one jigsaw puzzle, comprising the steps of:
setting a shape and outer perimeter of the jigsaw puzzle defined by an array of similarly shaped sectioning areas;
attaching a base image onto a first sectioning area;
manipulating the base image to create one or more manipulated images;
attaching the one or more manipulated images onto a second and any additional sectioning areas to create an overall symmetrical image; and
cutting the array into jigsaw puzzle pieces.

12. The process of claim 11, wherein each similarly shaped sectioning area has a defined perimeter boundary which, when rotated, aligns with the perimeter boundary of an adjacent sectioning area.

13. The process of claim 12, wherein jigsaw puzzle pieces within each sectioning area are cut according to the same pattern.

14. The process of claim 11, wherein the manipulating step comprises the step of creating a mirror image of the base image.

15. The process of claim 11, wherein the manipulating step comprises the step of rotating the base image.

16. The process of claim 11, wherein the array of similarly shaped sectioning areas comprises rectangles.

17. The process of claim 11, wherein the base image is asymmetrical.

18. The process of claim 11, wherein the base image comprises a portion of a recognizable article or thing.

19. The process of claim 11, wherein a second base image is provided on a back side of the first sectioning area and the steps of claim 11 are utilized to create a second multiple-in-one jigsaw puzzle on a back face of the original jigsaw puzzle.

20. The process of claim 11, wherein the steps of creating a multiple-in-one jigsaw puzzle are accomplished on a mobile electronic device.
